(19) United States
(12) Patent Application Publication
(10) Pub. No.: US 2005/0271046 A1
(43) Pub. Date: Dec. 8, 2005

(54) Packet switching system

(76) Inventors: Andrea Bianco, Torino (IT); Fabio Neri, Turin (IT); Mirko Franceschinis, Torino (IT); Emilio Leonardi, Torino (IT); Stefano Ghisolfi, Torino (IT); Alan Michael Hill, Woodbridge (GB); Terrence Geoffrey Hodgkinson, Woodbridge (GB); Albert Rafel, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/522,730

(22) PCT Filed: Aug. 6, 2003
(86) PCT No.: PCT/GB03/03406

§ 371 Date: Feb. 1, 2005

(30) Foreign Application Priority Data
Aug. 9, 2002 (GB) 0218565.0
Dec. 11, 2002 (GB) 0228917.1
Dec. 11, 2002 (GB) 0228904.9
Dec. 11, 2002 (GB) 0228903.1

(51) Int. Cl. H04L 12/56

(52) U.S. Cl. 370/386; 370/419

(57) ABSTRACT

In a packet switch, a switch request allocation plan is generated by reducing the number of queue requests VOQ relating to each of one or both sets of ports I1 .IN, O1 .ON, by a value such that the number of requests relating to each member of the set or sets of ports is no greater than the number of requests (frame value F) that can be handled by the switch (10). This reduction may be individually done for each queue. Alternatively all queues relating to a given port, or to any port, may have their length reduced by a single value determined by the size of the longest queue. A further stage may then apply other allocation rules to allocate requests remaining unallocated by the previous stage.

This invention relates to packet switching systems (also known as cell switching systems) for communications networks, in particular methods for allocating output switching requests for traffic from the inputs of a packet switch to its outputs. Fixed data units (slots) for switching are created by processing input packets as necessary or by any other means such as forecasting.

Input-buffered packet switches and routers offer potentially the highest available bandwidth for any given fabric and memory technology, but such systems require accurate scheduling to make the best use of this bandwidth. In such a scheduling process the header of each incoming packet is processed to identify its destination and the individual packets are then buffered in corresponding input queues, one for each possible pairing of input port with output port (port pair). The scheduling process itself then determines a permutation (a switch configuration or an input/output switch port assignment) in which packets from the input queues should be transmitted such that conflicts do not occur, such as two packets from different inputs competing for the same slot in the output ports.

On each cycle of, many scheduling algorithms check the occupancy of only the first queue position (head of line) from each queue, but some check the occupancy of a group of queue positions (known as “frames”) as this is more efficient. A frame-based scheduler determines, in one process, a set of switch permutations (one permutation per slot duration) in the next frame period (the processed/scheduled frame).

Scheduling is one of the most serious limiting factors in Input-Buffered packet switches. Scheduling generally consists of two sub-processes, namely matching (or arbitration), and time slot assignment (or switch fabric path-search). Matching is essentially the selection of packets from the input queues to maximise throughput within the constraints of frame lengths within both input and output ports (the “no-overbooking” constraint). Time slot assignment is the generation of a set of permutations (switching matrix configurations) for routing the packets (slots) through the switch for each slot duration.

A suitable scheduling process must satisfy two conditions; firstly the matching process must ensure that a “no overbooking” criterion is met for each input port and each output port (the “matching” problem). In other words it must arrange that the number of packets to be handled by each port (input and output), will not exceed the frame length (in number of time-slots) during the duration of the frame: ideally it should equal the frame length for each port, but this is not always possible as will be explained. Secondly, the time-slot assignment process must allocate all the matched requests for data units (time slots) for switching (in each permutation) during the frame time period. The present invention relates to the matching step of the scheduling process, which will be described in more detail later, after this overview of the whole packet switching system.

The packets are transmitted along a circuit established through the switch fabric according to a switching matrix (set of permutations) generated in the scheduling process just described. An output buffering stage may be provided in the output line cards before the packets are launched into the output links.

Maximum Size and Maximum Weight bipartite graph matching algorithms exist, which can theoretically achieve 100% throughput, but the complexity of their implementation makes them slow and their application unfeasible. However, although the Maximunm Weight and, in some circumstances, also the Maximum Size algorithms may solve the scheduling problem they are too complex to use on a per packet basis. There also exist more recent approaches based on Birkhoff and Von Neumann's request matrix decomposition, but these generate long delays and thus are inappropriate for real-time scheduling. Hence, iterative, heuristic, parallel algorithms such as the i-SLIP process [N. McKeown, “The i-SLIP scheduling algorithm for input-queued switches”. IEEE Transactions on Networking, vol. 7, no. 2, April 1999] and the Frame-based process have been developed. These heuristic algorithms are faster but, in the nature of heuristic algorithms, they do not provide a rigorous solution.

The “i-SLIP” scheduling algorithm, is an example of one that may operate slot-by-slot, (i.e. with a frame length of a single data unit or time-slot) but alternatively it may use a frame-based approach where input queues' occupancies are each checked once every F time-slots, where the value of F is greater than one: this interval of F timeslots is known as a “frame”. The result of the scheduling process is a N×F Switch Matrix C, where N is the number of the switch input ports, from which switching configurations (set of permutations) are decided for the next frame-switching time period. The content of each element c(i,s) of the matrix C is the Switch Fabric Output Port number to which the “s”th slot of the frame coming from the “i”th input port is to be routed. Note that some elements in matrix C may be empty. Typically there are the same number of output ports as there are input ports (N). This is always likely to be the case unless there is a preponderance of one-way communications connections served by the switch.

The scheduling problem will now be described in more detail.

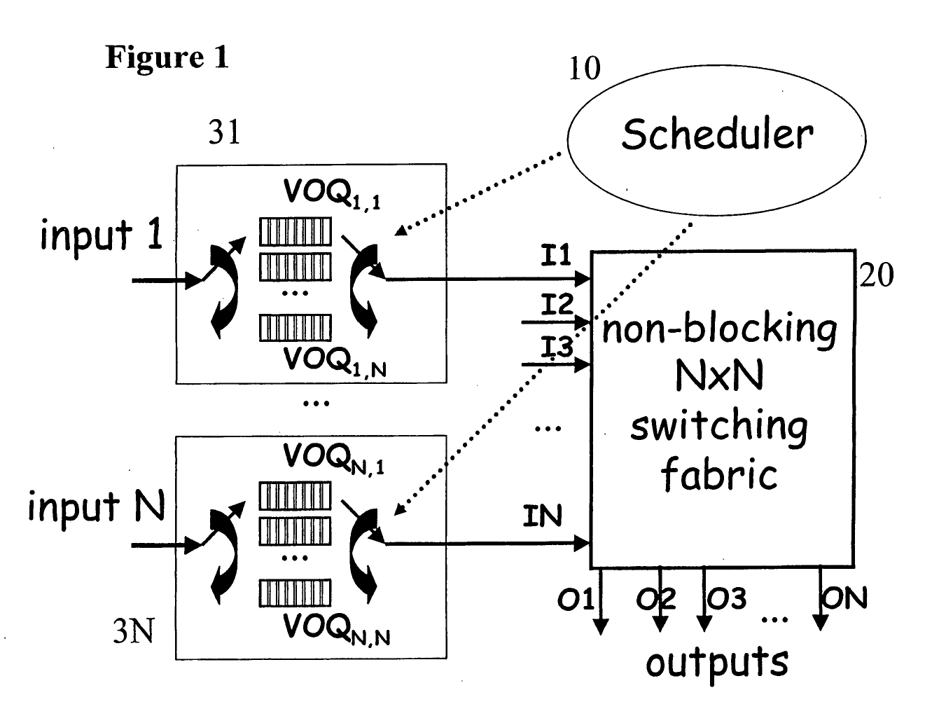

After the required output port of each incoming packet is identified, by processing the header or otherwise, the individual packets are buffered in corresponding input queues depending on the particular requested input/output port pair (VOQ). In order to establish the number of packets (time-slots), a counter is established for each queue (VOQ). Referring to FIG. 1, which shows a typical switch system, the Switch Fabric 20 has N input ports 31 . . . 3N (labelled input I₁ to input I_{N}) and N output ports (labelled output O₁ to output O_{N}). The switching is under the control of a scheduler 10. In respect of each input port “i” the scheduler 10 maintains N queues (one per Output port “j”), labelled VOQ_{i,j} in FIG. 1, in which data units (slots) destined for the respective output port are buffered. Therefore in total there are N² Virtual Output queues, and N² counters.

The number of switching Requests, for each Input port/Output port pair are stored in an N×N Request Matrix R. Each element r(i,j) of this matrix shows the total number of packets pending in the VOQ between input port ‘i’ and output port ‘j’.

In the example to be described below with reference to FIG. 1, a switch fabric with N=4 is used for simplicity, but in a typical switch the value of N is a much larger number. A switching-time period (period for which permutations are decided) is for the duration of one frame (F slots), which can be one or more slots. This means that the matrix R is updated once per frame time-period (with the intention that as many as possible of the packets represented therein, according to the maximum switch capacity, will be switched during the following time period).

$$\begin{matrix}\frac{Outlets ‘ j ’ ->}{Inlets ‘ i ’ ↓} & \begin{matrix}{O}_{1} & {O}_{2} & {O}_{3} & {O}_{4}\end{matrix} \\ \begin{matrix}{I}_{1} \\ {I}_{2} \\ {I}_{3} \\ {I}_{4}\end{matrix} & \begin{matrix}3 & 4 & 2 & 0 \\ 5 & 0 & 1 & 0 \\ 8 & 5 & 1 & 3 \\ 2 & 0 & 2 & 6\end{matrix}\end{matrix} R = ( \begin{matrix}3 & 4 & 2 & 0 \\ 5 & 0 & 1 & 0 \\ 8 & 5 & 1 & 3 \\ 2 & 0 & 2 & 6\end{matrix} ) \qquad ( 1 )$$

Matrix (1) represents a Request Matrix that will be used in this example, which has no further purpose other than to illustrate the scheduling process. Note that the total number of buffered packets for each port varies, in this example, between six (input 12 and also output O₃) and eighteen (output O₁), and cannot therefore match the frame size for all ports. Therefore, either some packets will not be switched, (the data either being discarded or held over to the next frame), or some slots will be unused as there are not enough packets to use them all. In general the frame size is predetermined or could vary for each frame-period. Nonetheless it will be fixed for the duration of a frame scheduling.

In the matching process, a number of packets “F” corresponding to the frame length, selected from packets buffered at each input port queue are checked for acceptance, to make sure that there is no overbooking of the input and output ports within the frame. An N×N “Accepted-Requests Matrix” A is defined, whose elements a_{i,j} represent the number of packet switching requests that are accepted from input port ‘i’ destined for output port ‘j’ in the next time period. The two conditions that ensure no overbooking are simply:

$${\sum }_{j = 1}^{N} {a}_{i , j} ≦ F for all i , and {\sum }_{i = 1}^{N} {a}_{i , j} ≦ F for all j .$$

Packets destined for overbooked ports may be discarded, or they may continue to be queued for transmission in later frames, if accuracy is more important than latency (delay time).

From the matrix R discussed above, the Matching process populates an N×N Accepted-Requests Matrix A. The values of the elements in this matrix are such that the switch input and output ports capacity is not exceeded, i.e. none of the row and column summations in this matrix exceeds F, which is the number of time slots (data units) that will be switched during the following time period. Note that we can generalise this definition to all Matching Algorithms, whether frame-based or not, saying for example that in a slot by slot process, such as the i-SLIP algorithm, the value of F is unity.

Matrix A below is an illustrative solution to the problem for the requests matrix R from (1). With a switching fabric with N=4 and a frame length F=8, the total switch capacity is N×F time-slots per time-period, which in this example is 32.

$$\begin{matrix}\frac{Outlets ‘ j ’ ->}{Inlets ‘ i ’ ↓} & \begin{matrix}{O}_{1} & {O}_{2} & {O}_{3} & {O}_{4}\end{matrix} & Row - Sums ↓ \\ \begin{matrix}{I}_{1} \\ {I}_{2} \\ {I}_{3} \\ {I}_{4}\end{matrix} & \begin{matrix}2 & 4 & 2 & 0 \\ 3 & 0 & 1 & 0 \\ 2 & 3 & 1 & 2 \\ 1 & 0 & 2 & 5\end{matrix} & \begin{matrix}8 \\ 4 \\ 8 \\ 8\end{matrix} \\ Column - Sums -> & \begin{matrix}8 & 7 & 6 & 7\end{matrix} & \begin{matrix}Total Sum = 28 \\ N \times F = 32\end{matrix}\end{matrix} \\ A = ( \begin{matrix}2 & 4 & 2 & 0 \\ 3 & 0 & 1 & 0 \\ 2 & 3 & 1 & 2 \\ 1 & 0 & 2 & 5\end{matrix} ) \qquad ( 2 )$$

A Matching algorithm attempts to completely fill up the matrix A taking the requests from matrix R, in such a way that the total switching requests for every input and output port does not exceed the value F (No-overbooking), and the total capacity of the Switch (N×F) is achieved. We see that the example shown here has not achieved filling the matrix A to the maximum switch capacity (32 requests), but only 28. In fact, because the input queues are not balanced, it is not possible to fill the remaining four slots in this example.

The solution represented by illustrative matrix A could be achieved reasonably quickly by trial and error from the matrix R. However, in practice switch fabrics have values for N (the number of ports) much greater than the illustrative value of 4 and a systematic approach is required. The present invention presents such an approach. Before the invention is discussed, there follows a description of the subsequent stages in the process.

Usually, the Matching Algorithms only check the occupancy (by inspecting the counters) of the first locations in each virtual output queue, or input-output pair queue (heads of queues) to a maximum of F locations per input port (i.e. all virtual queues corresponding to the same input port), without taking into account all switching requests. There exist some Matching Algorithms that check the occupancy of a higher number of queue locations, for instance a multiple of the value of F. For example, if F=8, we could check occupancy in the first 16 locations (2F) in each backlogged input queue to try to completely populate the Accepted-Requests Matrix A.

On the other hand, some Matching Algorithms use a number of iterations. This means that part of the algorithm is run more than once, always using the same queue locations as in the first time. This usually improves the filling ratio of the Accepted-Requests Matrix and therefore the switching throughput. Examples include i-SLIP (i>1), or Framebased algorithms using some variants of the port pointer update rule [A. Bianco et al., “Frame-based scheduling algorithms for best-effort cell or packet switching”, Workshop on High Performance Switching and Routing, HPSR 2002, May 2002, Japan]. Different versions of the frame-based algorithm have different rules for updating the port pointers and some variants of the frame-based algorithm look twice at the buffer occupancies on the same locations. For example, the versions known as NOB-27 and NOB-25 both use the same update rule but NOB-27 runs part of the process twice on the same buffer locations. Once the accepted requests matrix A has been generated, the second sub-process in the scheduling algorithm computes the set of switch permutations and assigns the time-slots within a frame to the accepted requests for each one of the permutations. In this way the switch fabric can be configured for each time slot avoiding conflicts at the output ports, i.e. there is at most one packet from any input queue to one particular output port. This process can be referred to as Time Slot Assignment (TSA). From the matrix of accepted requests A, we build the NxF Switch Matrix C. The elements c(i,s) of C show the output port number to which a switching request in input port ‘i’ will be switched in the slot ‘s’ of the frame of length F that is being scheduled. There are a number of algorithms to achieve this, among them the one described in the applicant's existing patent application W001/67802. Any particular packet should be capable of transmission across the switch fabric during any one of the time slots in the frame, although normally packets from the same queue (that is to say, between the same pair of ports) would be transmitted in the same order that they had originally arrived at the input port.

For example, from the illustrative “accepted requests” matrix A found in (2) the Switch Matrix C shown in (3) might be generated. The columns of matrix C represent the time-slots. At each time-slot the switch fabric has to be configured such that the packets present at the Input Ports are connected to the Output Port shown in each element c(i,s) of matrix C.

$$\begin{matrix}\frac{Time - slot ‘ s ’ ->}{Inlet ‘ i ’ ↓} & \begin{matrix}{S}_{1} & {S}_{2} & {S}_{3} & {S}_{4} & {S}_{5} & {S}_{6} & {S}_{7} & {S}_{8}\end{matrix} \\ \begin{matrix}{I}_{1} \\ {I}_{2} \\ {I}_{3} \\ {I}_{4}\end{matrix} & \begin{matrix}1 & 1 & 2 & 2 & 2 & 2 & 3 & 3 \\ 3 & & 1 & & 1 & & & 1 \\ 2 & 2 & 4 & 4 & 3 & 1 & 1 & 2 \\ 4 & 3 & 3 & 1 & 4 & 4 & 4 & 4\end{matrix}\end{matrix} \\ C = ( \begin{matrix}1 & 1 & 2 & 2 & 2 & 2 & 3 & 3 \\ 3 & & 1 & & 1 & & & 1 \\ 2 & 2 & 4 & 4 & 3 & 1 & 1 & 2 \\ 4 & 3 & 3 & 1 & 4 & 4 & 4 & 4\end{matrix} ) \qquad ( 3 )$$

Therefore matrix C shows a set of possible switch fabric configurations for an entire frame period. Each column of matrix C shows a switch permutation with no output port conflicts, i.e., no column of matrix C contains more than one occurrence of any output port number. The matrix C is the final result of the entire scheduling problem. Note that where the frame size F=1, as for the “i-SLIP” algorithm, matrix C is a column vector (N×1 matrix), and therefore the time-slot scheduling algorithm is straightforward.

An output memory stage may be provided where the slots could be re-sequenced (re-ordering and/or closing gaps between slots belonging to the same original packet).

Scheduling is therefore made up of the matching problem, and the time slot assignment problem. In the matching problem switching requests are accepted in such a way that the switching capacity is not exceeded while achieving maximum throughput. The assignment problem selects a set of switch fabric configurations (permutations) within the frame-length. This has known exact solutions at acceptable complexities. However, some issues might arise due to slot sequencing that could lead to the necessity for an output memory stage where slots could be re-sequenced.

Although some hitherto known heuristic matching algorithms generally perform well, there are some situations in which their performance deteriorates, in particular with unbalanced traffic patterns and bursty traffic sources. The consequences are that these matching algorithms are unable to ensure the ideal 100% throughput, and therefore some packets will be dropped (lost). This type of situation is becoming increasingly significant, as it is foreseen that the network churn (traffic patterns) will become highly dynamic, and not predictable.

The performance degradation occurs because these algorithms check the queues' occupancy only within a limited number of locations in the input queues. Therefore when a particular input queue backlog keeps growing these algorithms do not necessarily serve it because they are unaware of such condition. This leads to inefficiency becoming apparent at high traffic loads for highly unbalanced traffic patterns, that is, when the number of packets requesting to be switched for one particular or more input-output port pairs is much higher than for the others. This is common to many prior art heuristic matching algorithms as this process only scan the occupancy of a specified limited number of locations in the backlogged input queues, eventually leading to some packets being processed too late in certain traffic conditions.

One aspect of the present invention seeks to overcome this weakness by splitting the problem into a number of stages. Another aspect applies a transformation process to the switching request matrix, factorising it with respect to the switch port capacities. Although this transformation process could be used on its own, it is preferably used as the initial stage of two or more stages according to the first aspect.

According to the present invention there is provided a method of allocating switch requests within a packet switch, the method comprising the steps of
(a) generating switch request data for each input port indicative of the output ports to which data packets are to be transmitted
(b) processing the switch request data for each input port to generate request data for each input port-output port pairing; and
(c) generating an allocation plan for the switch for a frame of a defined number of packets, by a first stage in which allocation rules are applied such that the number of requests from each input port and to each output port is no greater than the defined frame length, and one or more further stages in which allocation rules are applied to allocate requests remaining unallocated by the previous stage.

Each stage attempts a complete solution to maximising allocations, using the unallocated requests remaining from the previous stage. The stages may use the same or different allocation rules. Some of stages may arrive at their complete solutions by an iterative process, such as the NOB-27 process already referred to.

One of the stages may be a method according to the applicant's co-pending International application, having the same filing date as the present application and applicant's reference A30169WO, claiming priority from United Kingdom applications 0218565.0 and 0228917.1. This method comprises the steps of
(a) generating switch request data for each input port indicative of the output ports to which data packets are to be transmitted;
(b) processing the switch request data for each input port to generate request data for each input port-output port pairing; and
(c) generating an allocation plan by reducing the number of queue requests relating to each of one or both sets of ports by a value such that the number of requests relating to each member of the set or sets of ports is no greater than a predetermined frame value.

The transformation of the request data may be done by summing up the switching requests from each input port, or the switching requests to each output port, or both, and reducing the number of requests from each input port, and to each output port, in such cases where the number of requests is greater than the maximum capacity of the relevant port, by a factor selected such that the total number of requests from the corresponding input port or to the corresponding output port is no greater than the maximum capacity of the corresponding input port and the corresponding output port. Thus the queue with the greatest number of switching requests is identified and served so as to keep the packet switch in a stable state for any possible traffic pattern, provided the traffic is admissible, i.e., the average switch request rate to any output port does not exceed the line rate of that output port (this condition applies to any scheduling algorithm). This invention allows the matching process to achieve maximum possible throughput for any input traffic statistics and with any traffic pattern, at a low complexity.

The reduction of the request data may comprise reducing the number of requests in the input ports; and then reducing the number of requests in the resulting transformed request data where it still exceeds the capacity of the output ports. Alternatively the output ports may be considered before the input ports.

Alternatively, the reduction of the request data from each input port and to each output port may be done using a common factor selected such that the number of requests from each input port and to each output port is no greater than the maximum capacity of either port. This process is quicker, but may lose some possible allocations.

This process ensures that all queued requests are considered, and is computationally simple, and therefore relatively fast. However, it may leave some capacity unfilled and/or cause unnecessary delays. It is preferably followed by one or more other allocation processes to fill any remaining capacity.

Unallocated switch requests may be reserved for use in the next stage of switch request allocation, or abandoned if they have an expiry time.

The invention extends to a method of packet switching wherein the packets are switched on the basis of the allocated routing, and to a packet switch in which the input port-output port routing is allocated in accordance with the method of the invention, and packets are switched from an input port to a specified output port in accordance with the allocated routing.

An embodiment of the invention will now be described, by way of example, with reference to the drawings, in which

FIG. 1, which has already been discussed, illustrates a simplified packet switching system,

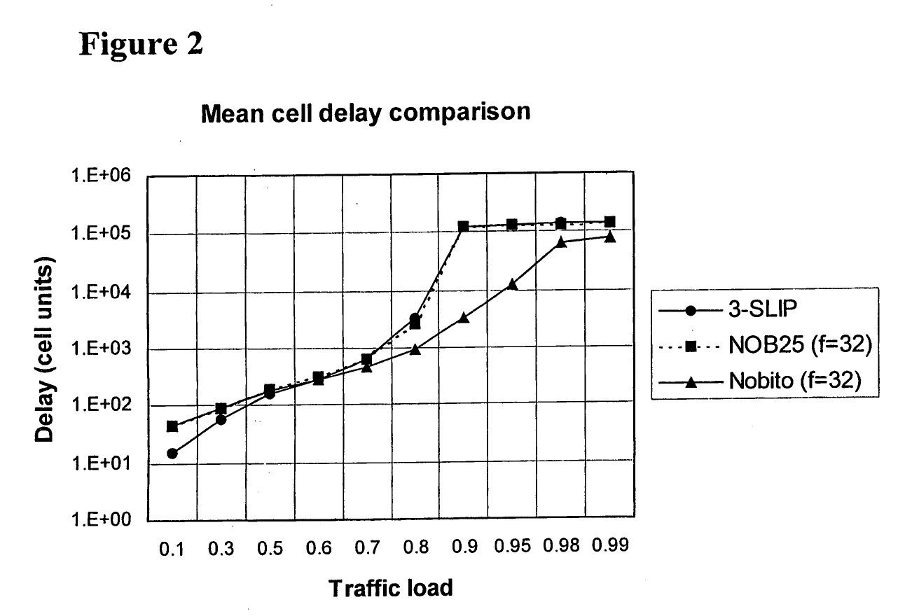

FIG. 2 is a graph comparing the performance of the i-slip algorithm, a frame-based algorithm using the NOB25 pointer update rule as described in an earlier patent application of the applicant (W001/67803), and a two-stage process according to the first aspect of the invention. The first stage of this two-stage process comprises request data reduction process using a common factor, according to the second aspect of the present invention. The second stage is the frame-based algorithm (NOB25) also used in the earlier patent application.

The matching process according to the present invention applies multiple stages. Traditional heuristic matching processes (e.g. i-SLIP and Frame-based) find matrix A directly from R,
R [symbol] A

The reduction of request data of the second aspect of the invention can be used on its own, but preferably precedes a heuristic matching algorithm, in general partially populating matrix A. In such a two-stage process, the original request matrix R₀=R is transformed to find a “normalised matrix” Rₙₒᵣₘ, in which the capacities of the input and output ports are not exceeded, and a “remaining request” matrix R₁, where R₁=R₀−Rₙₒᵣₘ. The matrix Rₙₒᵣₘ, is used to start to populate the Accepted-Requests Matrix A. The partially populated matrix will be referred to as A⁻.
A⁻≡Rₙₒᵣₘ

Now, to fill up the remaining capacity in the matrix A, it is necessary to use another matching algorithm. We could call this A⁺ matrix,
R₁ [symbol] A⁺

Now,
A=A⁻+A⁺

The matching matrix A is the sum of the two matrices found during a two-stage example of the present invention. A request matrix transformation may be applied to either stage, (preferably the first) applying to the second stage any other known matching algorithm, or it may be applied to both the first and second stages.

In general, the transformation presented here will precede the application of other matching algorithms.

Note that this splitting process can be reiterative in more than two stages, in each stage applying any transformation of this invention or any other known matching algorithm.

An example of the process of generating the transformed matrix, referred to herein as “Normalisation1”, and the subsequent stages, will now be discussed, using an exemplary Request matrix:

Outlets ‘j’

| Inlets ‘i’ | O₁ | O₂ | O₃ | O₄ | Row - Sums |
|---|---|---|---|---|---|
| I₁ | 3 | 4 | 2 | 0 | 9 |
| I₂ | 5 | 0 | 1 | 0 | 6 |
| I₃ | 8 | 5 | 1 | 3 | 17 |
| I₄ | 2 | 0 | 2 | 6 | 10 |
| Column - Sums → | 18 | 9 | 6 | 9 | Highest sum |
| | | | | | mval = 18 |

In this example there are, as before, four input ports and four output ports, and the frame length F is again 8. A value mval is derived from this matrix, which is the largest sum of any column or any row in the matrix, which in this case is the total number of requests for output port 1.

The process requires the transformation of the request matrix R₀ to find a matrix Rₙₒᵣₘ, in which the capacities of the input and output ports are not exceeded. The result is used to generate the partially filled matrix A⁻. The transformation performed in this example uses a common factor d=F/max(F, mval), which in the case of this example is d=8/18 or 0.44. In other words, if the number of requests in respect of any port-input or output-(mval) is greater than the frame length, the value of every term in the matrix is reduced by a factor such that the total number of requests in respect of that port is equal to, or less than, the frame length.

$${R}_{0} = ( \begin{matrix}3 & 4 & 2 & 0 \\ 5 & 0 & 1 & 0 \\ 8 & 5 & 1 & 3 \\ 2 & 0 & 2 & 6\end{matrix} ) ⇒ {R}_{norm} = ⌊ \frac{8}{18} {R}_{0} ⌋ = ( \begin{matrix}1 & 1 & 0 & 0 \\ 2 & 0 & 0 & 0 \\ 3 & 2 & 0 & 1 \\ 0 & 0 & 0 & 2\end{matrix} ) = {A}^{-}$$

and the remaining Request Matrix is

$${R}_{1} = {R}_{0} = {R}_{norm} = ( \begin{matrix}2 & 3 & 2 & 0 \\ 3 & 0 & 1 & 0 \\ 5 & 3 & 1 & 2 \\ 2 & 0 & 2 & 4\end{matrix} )$$

It will be seen that matrix A is not full yet. The remaining capacity in matrix A can then be filled using the updated matrix R₁ and for example the known Frame based algorithm of the applicant's existing International Patent Application W001/67803 using the pointer update rule NOB25, or the process described in the applicant's International patent application filed on the same date as the present case, having applicant's reference A30137WO and claiming priority from United Kingdom Patent Applications 0218565.0 and 0228903.1.

Further refinements of the invention will now be described.

The process “Normalisation 1” described above does not completely populate the matrix A, because of the generalisation of ‘mval’ to all elements in the matrix R₀. As a result, some Inlet-Outlet pairs in the R₀ matrix are not heavily loaded, and therefore could be allowed a smaller ‘mval’, i.e., a bigger transforming factor.

Limiting each column total to the frame length ensures that the “no overbooking” condition is met for each Output Port. Similarly, limiting each row total to the frame length analogously ensures “no overbooking” of all input ports. The following variant embodiment generates a separate value ‘mval’ for each term in the matrix, being the highest of three values: the respective totals for the row and column of which that term is a member, and the frame length. We therefore have a set of normalising factors that may be different for each element of matrix R₀. We arrange this set in a matrix form. This transformation is referred to herein as “Normalisation2”.

$$\begin{matrix}\frac{Outlets ‘ j ’ ->}{Inlets ‘ i ’ ↓} & \begin{matrix}{O}_{1} & {O}_{2} & {O}_{3} & {O}_{4}\end{matrix} & Row - Sums ↓ \\ \begin{matrix}{I}_{1} \\ {I}_{2} \\ {I}_{3} \\ {I}_{4}\end{matrix} & \begin{matrix}3 & 4 & 2 & 0 \\ 5 & 0 & 1 & 0 \\ 8 & 5 & 1 & 3 \\ 2 & 0 & 2 & 6\end{matrix} & \begin{matrix}9 \\ 6 \\ 17 \\ 10\end{matrix} \\ Column - Sums -> & \begin{matrix}18 & 9 & 6 & 9\end{matrix} & \end{matrix} ⇒ mval = ( \begin{matrix}18 & 9 & 9 & 9 \\ 18 & 9 & 6 & 9 \\ 18 & 17 & 17 & 17 \\ 18 & 10 & 10 & 10\end{matrix} )$$

In order to find each element r_{norm ij} of the normalised matrix Rₙₒᵣₘ we have

$${r}_{norm ij} = ⌊ {r}_{0 ij} \cdot \frac{F}{max ( F , {mval}_{ij} )} ⌋$$

where rₒᵢⱼ represent each element of the request matrix Rot and mivalᵢⱼ represent each element of the matrix mval. This operation results in the following normalised matrix

$${R}_{norm} = ( \begin{matrix}1 & 3 & 1 & 0 \\ 2 & 0 & 1 & 0 \\ 3 & 2 & 0 & 1 \\ 0 & 0 & 1 & 4\end{matrix} ) = {A}^{-}$$

It will be seen that in this particular example the highest summation (‘mval’) is that for column O₁, namely 18, and so all terms in the first column of the matrix are multiplied by 8/18=0.44 (all decimal figures approximated to two places). The next highest summation is in row I₃ (mval=17), so all terms in row I₃, except the first, are multiplied by 8/17=0.47. Similarly all terms in row 14 except the first are multiplied by 8/10=0.8, the remaining terms in row I₁ and columns O₂ and O₄ are all 8/9=0.89. Finally, Row I₂ and column O₃ both have an ‘mval’ of 6, which is less than the frame length, so the term at the intersection of that row and column takes the value of unity (not 8/6).

The Remaining Switch Request Matrix R₁ is then determined as:

$${R}_{1} = {R}_{0} - {R}_{norm} = ( \begin{matrix}2 & 1 & 1 & 0 \\ 3 & 0 & 0 & 0 \\ 5 & 3 & 1 & 2 \\ 2 & 0 & 1 & 2\end{matrix} )$$

In this case, we have been able to populate matrix A more densely than using the “Normalisation 1” process described above, leaving less work-load for the following stage. However, there is added complexity as now we need N² registers to store the ‘inmal’ matrix, instead of a single value.

A further development, referred to herein as “Normalisation3” consists in including a further phase (or step) and simplifying the first one within the transformation process. In this embodiment, the matrix R₀ is transformed using a vector in a first step and in a second step transforming only one of the ports. The vector can be derived from the ‘mvial’ of each individual row or, as shown below, each individual column, but otherwise follows the same procedure as previously described.

$$\begin{matrix}\frac{Outlets ‘ j ’ ->}{Inlets ‘ i ’ ↓} & \begin{matrix}{O}_{1} & {O}_{2} & {O}_{3} & {O}_{4}\end{matrix} & \\ \begin{matrix}{I}_{1} \\ {I}_{2} \\ {I}_{3} \\ {I}_{4}\end{matrix} & \begin{matrix}3 & 4 & 2 & 0 \\ 5 & 0 & 1 & 0 \\ 8 & 5 & 1 & 3 \\ 2 & 0 & 2 & 6\end{matrix} & \\ Column - Sums -> & \begin{matrix}18 & 9 & 6 & 9\end{matrix} & \end{matrix} ⇒ {mval}^{1} = ( \begin{matrix}18 & 9 & 6 & 9\end{matrix} )$$

$${r}_{norm ij}^{1} = ⌊ {r}_{0 ij} \cdot \frac{F}{max ( F , {mval}_{j}^{1} )} ⌋$$

where r₀ᵢⱼ represent the element in row i and column j of the request matrix R₀, and mvalⱼ¹ represent each element of the vector mval¹, j being the same value taken for the element r₀ᵢⱼ. Therefore each matrix element r₀ᵢⱼ belonging to the same column j will be normalised using the same factor resulting from F/max(F, mvalⱼ¹). This operation results in the first normalised matrix of the process that is

$${R}_{norm}^{1} = ( \begin{matrix}1 & 3 & 2 & 0 \\ 2 & 0 & 1 & 0 \\ 3 & 4 & 1 & 2 \\ 0 & 0 & 2 & 5\end{matrix} )$$

After this first step is finished, the second step considers each individual column or row, whichever was not done in the first step. Any of these which exceed the maximum capacity are transformed again, but they are otherwise left as they are. In this example, it can be seen from inspection of the third row of Rₙₒᵣₘ¹ that the request sum for input port 3 is still higher than the port capacity F:

| | | Outlets ‘j’ | | | | |
|---|---|---|---|---|---|---|
| | Inlets ‘i’ | O₁ | O₂ | O₃ | O₄ | Row - Sums |
| Rₙₒᵣₘ¹ = | I₁ | 1 | 3 | 2 | 0 | 6 |
| | I₂ | 2 | 0 | 1 | 0 | 3 |
| | I₃ | 3 | 4 | 1 | 2 | 10 > F |
| | I₄ | 0 | 0 | 2 | 5 | 7 |
| | Column - Sums → | 6 | 7 | 6 | 7 | |

From the matrix Rₙₒᵣₘ¹ we can find again a vector with the summing of each matrix row. Therefore
Rₙₒᵣₘ¹mval²=(6 3 10 7)
Now we can apply again the normalisation, that is

$${r}_{norm ij}^{2} = ⌊ {r}_{norm ij}^{1} \cdot \frac{F}{max ( F , {mval}_{i}^{2} )} ⌋$$

where r_{norm ij}¹ represent the element in row i and column j of the request matrix Rₙₒᵣₘ¹, and mvalᵢ² represent each element of the vector nzval², i being the same value taken for the element r_{norm ij}¹. Hence each matrix element r_{norm ij}¹ belonging to the same row i will be normalised using the same factor resulting from F/max(F, mvalᵢ²). Therefore we perform a further step in this stage, in which only the requests in the port where they exceed F (port capacity) are normalised by a factor F/mvalᵢ²=8/10 (note that in this particular case i=3), remaining the rest of the elements unchanged. This operation results in the second and final normalised matrix of the process that is

$${R}_{norm}^{2} = ( \begin{matrix}1 & 3 & 2 & 0 \\ 2 & 0 & 1 & 0 \\ 2 & 3 & 0 & 1 \\ 0 & 0 & 2 & 5\end{matrix} ) = {A}^{-}$$

$${R}_{1} = {R}_{0} - {R}_{norm}^{2} = ( \begin{matrix}2 & 1 & 0 & 0 \\ 3 & 0 & 0 & 0 \\ 5 & 2 & 0 & 2 \\ 2 & 0 & 0 & 1\end{matrix} ) Remaining Switch Request Matrix$$

This algorithm can also be started using the Input requests summations, and reducing the output requests in the second stage, instead of the other way round as described above.

Instead of reducing each value in a row or column by a common factor, a common value could instead be subtracted. FIG. 2 shows a comparison of the mean packet delay for three processes:
1. a prior art system known as i-SLIP with 3 iterations, labelled 3-SLIP in the figure,
2. the prior art Frame-based matching algorithm (W001/67803) previously discussed, using the pointer update rule NOB25, labelled NOB25 in the Figure.
3. the present invention, labelled NOBITO in the figure, using a Normalisation process similar to Normalisation 2, except that a single mval, equal to the largest sum of any row or column, was used for all terms in the matrixin the first stage and the same prior art Frame-based matching algorithm (with pointer update rule NOB25) as a second stage.

The Frame-based matching algorithm was run using one iteration and a 32 time-slot duration frame in all cases. The scenario is a 8×8 switch, using bursty packet arrivals with a mean burst duration of 256 packets, and with a traffic matrix P, in which element P(i,j) indicates the probable level of traffic between input port “i” and output port “j”:

$$P = \frac{1}{255} ( \begin{matrix}1 & 2 & 4 & 8 & 16 & 32 & 64 & 128 \\ 2 & 4 & 8 & 16 & 32 & 64 & 128 & 1 \\ 4 & 8 & 16 & 32 & 64 & 128 & 1 & 2 \\ 8 & 16 & 32 & 64 & 128 & 1 & 2 & 4 \\ 16 & 32 & 64 & 128 & 1 & 2 & 4 & 8 \\ 32 & 64 & 128 & 1 & 2 & 4 & 8 & 16 \\ 64 & 128 & 1 & 2 & 4 & 8 & 16 & 32 \\ 128 & 1 & 2 & 4 & 8 & 16 & 32 & 64\end{matrix} )$$

The results of FIG. 2 are for the links represented by the antidiagonal terms of this matrix.

FIG. 2 shows that the prior art systems are only capable of achieving a 90% throughout, while using the present embodiment it is able to achieve 100% throughput. Because the buffer lengths have to be finite, packets are dropped (lost) from the queues when they reach a maximum delay. This is shown in the graph, where the curves become horizontal.

Therefore, the invention shows all advantages of the i-SLIP and frame-based algorithms and dramatically improves the performance at high traffic loads for any type of traffic sources and traffic patterns. Following the first stage of the process, the second stage of the matching problem deals with the remaining request matrix filling in the rest of the slot switch capacity, using for example a single iteration of a frame-based algorithm.

Table 1 below presents a number of examples of the use of the present invention. Two different normalisation methods according to the present invention are compared. Normalisation method 3 assigns a separate ‘mval’ in the row and column for each r_{i,j} matrix entry. This means that some matrix entries could be rounded down twice. By normaliation 2 assigns the larger of the row and column ‘mval’ for each matrix entry. By assigning only one ‘mval’ to each matrix entry, each one is only rounded down once.

For the second stage, data is shown for three different variants: either of those disclosed in the applicant's co-pending applications A30137 referred to above, or W001/67803, (the latter using the NOB-25 rule) or another algorithm known as “Ring” which was proposed by Politecnico di Torino within the European Union's collaborative project DAVID [“Description of Network Concepts and Frame of the Work”, DAVID (IST-1999-11742) project Deliverable D11, March 2002]. This ‘Ring’ algorithm is a greedy maximal approximation of a maximum weight matching [R. E. Tarjan, “Data Structures and Network Algorithms”, Society for Industrial and Applied Mathematics, November 1983], a well known problem in graph theory.

Data is also shown for a single stage process, and for processes having two similar stages.

The resulting Accepted-Requests Matrices A for each combination shown in Table 1 are shown in Table 2. In this example it is seen that the examples using a preliminary stage of the normalisation process 2 (examples d,e, and f) and Normalisation Process 3 (examples g, h, and l) of the present invention provide a higher filling cardinality than those which do not. Of those, the Frame-based algorithm (using NOB25 rule) process (examples f and i) generate a larger number of filled requests, (up to 28) but the filled matrices of the “Ring” process, (examples d and g) and of our co-pending application A30137 referred to above (examples e and h) provide a better match to the proportions of the original Request matrix R₀, i.e., closer to a maximum weight matching.

TABLE 1
Comparison of different combinations of algorithms in
a two-stage implementation of the present invention.

| | | | Cardinality |
|---|---|---|---|
| | Stage 1 | Stage 2 | (No of Accepted Requests) |
| a) | (No first stage) | A30137 | 23 |
| b) | Ring | Ring | 25 |
| c) | A30137 | A30137 | 23 |
| d) | Normalisation2 | Ring | 26 |
| e) | Normalisation2 | A30137 | 26 |
| f) | Normalisation2 | WO01/67803 | 28 |
| g) | Normalisation3 | Ring | 27 |
| h) | Normalisation3 | A30137 | 27 |
| i) | Normalisation3 | WO01/67803 | 28 |

TABLE 2
Accepted-Requests Matrices, using the
different combinations of Table 1.

| A = | | |
|---|---|---|
| $\begin{matrix}a ) \\ [ \begin{matrix}0 & 4 & 2 & 0 \\ 0 & 0 & 1 & 0 \\ 8 & 0 & 0 & 0 \\ 0 & 0 & 2 & 6\end{matrix} ]\end{matrix}$ | $\begin{matrix}b ) \\ [ \begin{matrix}0 & 4 & 2 & 0 \\ 2 & 0 & 1 & 0 \\ 6 & 2 & 0 & 0 \\ 0 & 0 & 2 & 6\end{matrix} ]\end{matrix}$ | $\begin{matrix}c ) \\ [ \begin{matrix}0 & 4 & 2 & 0 \\ 0 & 0 & 1 & 0 \\ 8 & 0 & 0 & 0 \\ 0 & 0 & 2 & 6\end{matrix} ]\end{matrix}$ |
| $\begin{matrix}d ) \\ [ \begin{matrix}1 & 4 & 2 & 0 \\ 2 & 0 & 1 & 0 \\ 5 & 2 & 0 & 1 \\ 0 & 0 & 2 & 6\end{matrix} ]\end{matrix}$ | $\begin{matrix}e ) \\ [ \begin{matrix}1 & 4 & 2 & 0 \\ 2 & 0 & 1 & 0 \\ 5 & 2 & 0 & 1 \\ 0 & 0 & 2 & 6\end{matrix} ]\end{matrix}$ | $\begin{matrix}f ) \\ [ \begin{matrix}2 & 4 & 2 & 0 \\ 3 & 0 & 1 & 0 \\ 3 & 2 & 1 & 2 \\ 0 & 0 & 2 & 6\end{matrix} ]\end{matrix}$ |
| $\begin{matrix}g ) \\ [ \begin{matrix}1 & 4 & 2 & 0 \\ 3 & 0 & 1 & 0 \\ 4 & 3 & 0 & 1 \\ 0 & 0 & 2 & 6\end{matrix} ]\end{matrix}$ | $\begin{matrix}h ) \\ [ \begin{matrix}1 & 4 & 2 & 0 \\ 3 & 0 & 1 & 0 \\ 4 & 3 & 0 & 1 \\ 0 & 0 & 2 & 6\end{matrix} ]\end{matrix}$ | $\begin{matrix}g ) \\ [ \begin{matrix}2 & 4 & 2 & 0 \\ 3 & 0 & 1 & 0 \\ 2 & 3 & 1 & 2 \\ 0 & 0 & 2 & 6\end{matrix} ]\end{matrix}$ |

1. A method of allocating switch requests within a packet switch, the method comprising the steps of
(a) generating switch request data for each input port indicative of the output ports to which data packets are to be transmitted;
(b) processing the switch request data for each input port to generate request data for each input port-output port pairing;
(c) generating an allocation plan for the switch for a frame of a defined number of packets, by a first stage in which allocation rules are applied such that the number of requests from each input port and to each output port is no greater than the defined frame length, and one or more further stages in which allocation rules are applied to allocate requests remaining unallocated by the previous stage.

2. A method according to claim 1, wherein unallocated switch requests are reserved for use in a subsequent stage of switch request allocation.

3. A method according to claim 1, wherein at least one of the stages is a process comprises the steps of (a) generating switch request data for each input port indicative of the output ports to which data packets are to be transmitted; (b) processing the switch request data for each input port to generate request data for each input port-output port pairing; (c) generating an allocation plan by reducing the number of queue requests relating to each of one or both sets of ports by a value such that the number of requests relating to each member of the set or sets of ports is no greater than a predetermined frame value.

4. A method according to claim 3, wherein the transformation of the request data is done by using the summations of the requests from each input port.

5. A method according to claim 3, wherein the transformation of the request data is done by using the summations of the requests to each output port.

6. A method according to claim 3, wherein the reduction of the request data from each input port and to each output port is done, in such cases where the number or requests is greater than the maximum capacity of the corresponding input port or corresponding output port, the reduction being by a factor selected such that the number of requests from the corresponding input port and to the corresponding output port is no greater than the maximum capacity of the corresponding input port and the corresponding output port.

7. A method according to claim 3, wherein the reduction of the request data from each input port and to each output port is done using a common factor selected such that the number of requests from each input port and to each output port is no greater than the maximum request capacity of each input port and each output port.

8. A method according to claim 3, wherein the reduction of the request data comprises
(a) reducing the number of requests to each output port; and
(b) reducing the number of requests in the resulting reduced request data that exceeds the capacity of each input port.

9. A method according to claim 3, wherein the transformation of the request data comprises
(a) reducing the number of requests from each input port; and
(b) reducing the number of requests in the resulting reduced request data that exceeds the capacity of each output port.

10. A method according to claim 3, wherein the process is iterative, and is repeated one or more times in respect of input ports and output ports for which capacity remains available after the previous iteration is complete.

11. A method of packet switching wherein the input port-output port routing is allocated according to the method of claim 1 and the packets are switched on the basis of the allocated routing.

12. A packet switch in which the input port-output port routing is allocated in accordance with the method of claim 1.

13. A packet switch according to claim 12, wherein packets are switched from an input port to a specified output port in accordance with the allocated routing.
